(19) United States
(12) Patent Application Publication
(10) Pub. No.: US 2006/0293481 A1
(43) Pub. Date: Dec. 28, 2006

(54) Novel Method for the preparation of vinyl carbonate capped polydimethylsiloxanes

(76) Inventors: David Seelye, Rochester, NY (US); Jay Kunzler, Canandaigua, NY (US); Richard Ozark, Solvay, NY (US)

Correspondence Address: Bausch & Lomb Incorporated, One Bausch & Lomb Place, Rochester, NY, 14604-2701, US

(21) Appl. No.: 11/472,234

(22) Filed: Jun. 21, 2006

Related U.S. Application Data
(60) Provisional application No. 60/692,663, filed on Jun. 21, 2005.

(51) Int. Cl. C08G 77/20

(52) U.S. Cl. 528/32; 528/12; 528/37

(57) ABSTRACT

This invention relates to the preparation of vinyl carbonate capped polydimethylsiloxanes. More specifically, the invention relates to the preparation of vinyl carbonate capped polydimethylsiloxanes for use in forming optically clear medical devices by the ring opening siloxane rearrangement polymerization using water content standardized cation exchange resins as the catalytic species.

### FIELD

This invention relates to the preparation of vinyl carbonate capped polydimethylsiloxanes. More specifically, the invention relates to the preparation of vinyl carbonate capped polydimethylsiloxanes for use in forming optically clear medical devices by the ring opening siloxane rearrangement polymerization using water content standardized cation exchange resins as the catalytic species.

### BACKGROUND

V₂D₂₅ (RD352) is a siloxane cross-linker used in the production of medical devices. The chemical structure of V₂D₂₅ is provided below: 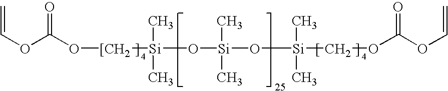
Presently, the synthesis of RD352 involves a triflic acid catalyzed ring opening polymerization of octamethylcyclotetrasiloxane with a vinyl carbonate butylcapped tetramethyldisiloxane. One of the major problems with this synthetic route is that an intense black color forms immediately following the addition of the triflic acid catalyst. The species responsible for the color has not been identified. The removal of this color requires several lengthy and expensive decolorization steps. Despite these efforts to decolorize the RD352 prepared by triflic acid catalyst ring opening polymerization, the color, in fact, is never fully removed. The final product, after the decolorization steps, is a yellow to orange fluid. In addition to the color problem of the prior art reaction, it has been determined that a portion of the vinyl carbonate end-cap degrades during the ring-opening step resulting in a non-polymerizable by-product.

Therefore, the problem addressed by the invention herein is that current methods of making monomers such as RD352 for use in preparing optically clear medical devices results in materials having a dark color and non-polymerizable by products. Although the dark color may be minimized by the use of additional decolorization steps, it would be desirable to provide a method of synthesizing monomers for use in preparing optically clear medical devices that results in a clear monomer product.

Ring-opening polymerization of orgnopolysiloxanes is known. For example, U.S. Pat. No. 5,504,234 to Omura et al. discloses a method for the preparation of a (meth)acryloxyalkyl group-containing organopolysiloxane having a linear structure by the ring-opening siloxane rearrangement polymerization reaction of a (meth)acryloxyalkyl group-containing cyclic organopolysiloxane oligomer either alone or in combination with a cyclic organopolysiloxane oligomer having no (meth)acryloxyalkyl groups. Different from conventional acidic catalyst, the reaction can be promoted by the use of a cation-exchange resin in the H⁺ form which can be readily removed from the polymerization mixture after completion of the polymerization reaction leaving no acidic matter which influences on the stability of the product. The catalytic efficiency of the cation-exchange resin can be further enhanced when the resin is, prior to contacting with the cyclic organopolysiloxane oligomer(s), impregnated or swollen with a polar organic solvent such as tetrahydrofuran. The Omura patent does not standardize the water content of the ion-exchange resins used and the synthesis is run at an elevated temperature of 60° C.

Therefore, there is still a need to provide a reaction mechanism that provides the desired monomer in good yield and of optically clear quality for the production of optically clear medical devices.

### SUMMARY

Provided herein are methods of forming monomers for use in forming medical devices. The method consists of extracting the ion-exchange resin first with a polar solvent such as THF followed by washing with a 0.5% N HCl and distilled water to achieve acidic pH. The washed and acidified resin is then dried, for instance in a vacuum oven, until 100% solids is obtained. The dried resin along with 10% by weight water (based on the weight of the resin) is then added to a reaction vessel containing octamethylcyclotetrasiloxane and vinyl carbonate capped disiloxane at a concentration to yield a desired statistical chain length. The contents of the reaction vessel are stirred vigorously at room temperature for about 96 hours followed by filtration to remove the ion-exchange resin. The final product is an optically clear viscous fluid.

### BRIEF DESCRIPTION OF THE DRAWINGS

FIG. 1 is a gas chromatogram of the distillate from a thin film evaporator used to purify monomer prepared according to the prior art;

FIG. 2 is a gas chromatogram of the distillate from a thin film evaporator used to purify monomer prepared according to the method of the invention herein.

### DESCRIPTION

As is described above, the most characteristic feature in the inventive method consists in the use of a water content standardized cation-exchange resin in the acidified form (i.e., normalized) as a catalyst for the ring-opening siloxane rearrangement polymerization reaction of the cyclic organopolysiloxane oligomer or oligomers in place of conventional acids as an acidic catalyst. After completion of the polymerization reaction, the cation-exchange resin can be easily removed from the reaction mixture by filtration leaving an organopolysiloxane product that can be used in the manufacture of medical devices. Such medical devices would include contact lenses, phakic intraocular lenses, aphakic intraocular lenses, corneal implants, etc.

The method of the present invention is basically a ring-opening siloxane rearrangement polymerization reaction of a cyclic organopolysiloxane oligomer such as an octamethylcyclotetrasiloxane as the component (a), and an end capped disiloxane such as vinylcarbonate capped disiloxane as component (b). When a mixture of the oligomers (a) and (b) is subjected to the polymerization reaction, the weight proportion of component (a) should be at least about 75% based on the amount of the mixture since, when the proportion of the component (a) is too small, the linear organopolysiloxane obtained as the product has no particular functional merit over conventional diorganopolysiloxanes such as dimethyl polysiloxanes containing no vinyl carbonate functional groups.

The above mentioned cyclic organopolysiloxane oligomer as the component (a) is typically a cyclic oligomer (D4) expressed by the formula:

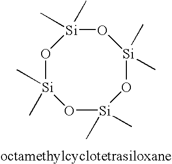

The above mentioned end capped disiloxane oligomer (V2) as the component (b) is typically expressed by the formula:

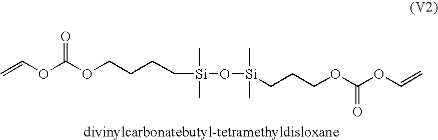

In step (A) of the inventive method, the above described cyclic organopolysiloxane oligomer or oligomers are (a and b) blended with a cation-exchange resin in the water standardized acidic form as the component (c) to give a polymerization mixture.

The cation-exchange resin used as component (c) is decolorized and cleaned and standardized to a desired level of water content (i.e., normalized) prior to combining with components (a) and (b). The desired level of water content serves to control the relative amount of monofunctionality of the end product. The first step in preparing the standardized resin is to decolorize the resin. This is achieved through washing the ion-exchange resin with any suitable resin expanding solvent such as THE, polar solvents, acetyl nitrile, toluene, etc. The selection of a suitable resin expanding solvent is within the purview of one of ordinary skill in the art. Preferred solvents are HPLC grade to avoid the introduction of undesired materials into the standardized resins. After decolorizing, the resin is then cleaned with high purity water and dried to constant weight. After drying, the resin is washed with mineral acid solution such as 0.5N HCl to remove any unbound acids. The resin is then washed with high purity water until the wash water is acidic. This indicates that any unbound acids have been removed. The resin is then dried again to provide the activated resin. After activation of the resin, an amount of water is added to the resin to control the degree of water content of the resin. Controlling the degree of water content of the resin allows one to control the amount of mono-functional product. The controlled degree of water content of the resin is what is meant as “water content standardized resin” or words of similar import.

It was also determined that the glassware used in performing the resin activation and standardization procedure should be cleaned with Aqua Regia prior to performing the resin activation and standardization procedure. This cleaning step removes any silicone stopcock grease as well as any trace of the Alcoholic KOH normally used to wash laboratory glassware. Acetone is used for the final rinse step of the glassware used in the resin activation and standardization procedure.

Various grades of commercial products of dry-type cation-exchange resins are available on the market and can be used in the resin activation and standardizing procedure including Amberlyst 15 E Dry manufactured by Rohm & Haas Co. and Purolites CT-165, CT-169, CT-171DR and CT-175 manufactured by Purolite Co.

The amount of the above described cation-exchange resin in the polymerization mixture is in the range from about 5 to about 15% by weight or, preferably, from about 3 to about 5% by weight based on the amount of the cyclic organopolysiloxane oligomer or oligomers. When the amount of the cation-exchange resin is too small, the velocity of the polymerization reaction cannot be high enough as a matter of course while, when the amount thereof is too large, a substantial amount of the diorganopolysiloxane product adheres to the resin particles and cannot be recovered resulting in a decrease in the product yield with no particular additional advantages in the velocity of polymerization or in other respects.

Besides the above described cyclic organopolysiloxane oligomer or oligomers, the polymerization mixture is admixed with an oligomeric diorganopolysiloxane or, in particular, dimethyl polysiloxane terminated at each molecular chain end with a trimethyl silyl group or dimethyl (meth)acryloxyalkyl silyl group with an object to provide terminal groups to the linear diorganopolysiloxane product.

The polymerization mixture prepared by mixing the above described ingredients is then, in step (B) of the inventive method, agitated at room temperature for a length of time, usually, in the range from about 4 to about 120 hours to effect the ring-opening polymerization of the cyclic oligomer or oligomers. In step (C) of the inventive method, thereafter, the linear diorganopolysiloxane thus formed in the reaction mixture is freed from the beads of the cation-exchange resin by filtration using, for example, a metal wire screen of suitable mesh openings. No particular difficulties are encountered in this filtration treatment.

The cation-exchange resin recovered by separating from the polymerization mixture by filtration can be re-used as such in the next run of the polymerization reaction. It has been discovered that the catalytic activity of the thus recovered cation-exchange resin can be more fully regained by washing the resin beads separated from the polymerization mixture of the previous run with a polar organic solvent as completely as possible or, for example, with the polar organic solvent in an at least equal amount to the resin so that the resin is freed from the adhering organopolysiloxane. The organopolysiloxane dissolved away from the resin beads by washing can be recovered by removing the solvent from the washings under reduced pressure so that no decrease is caused in the yield of the product due to washing of the cation-exchange resin with a polar organic solvent.

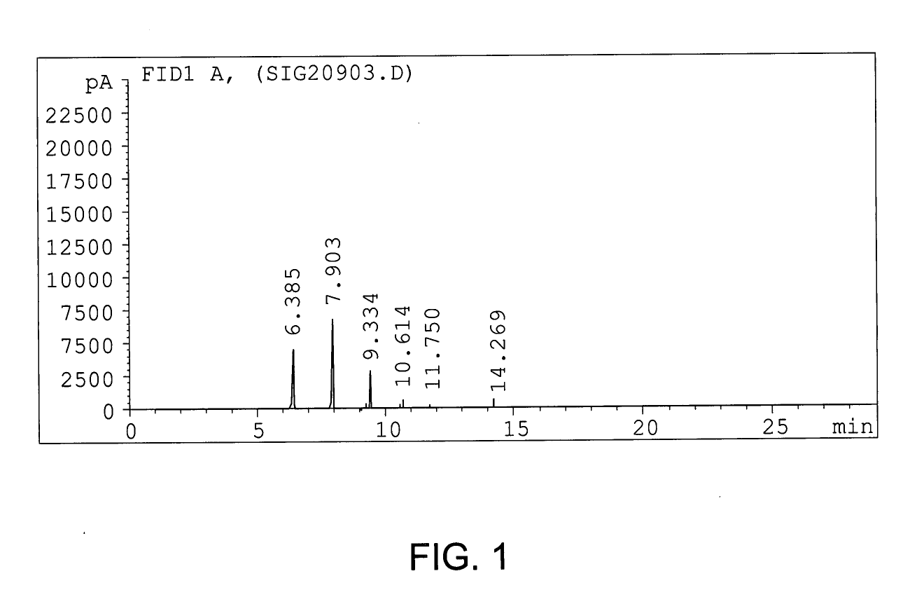

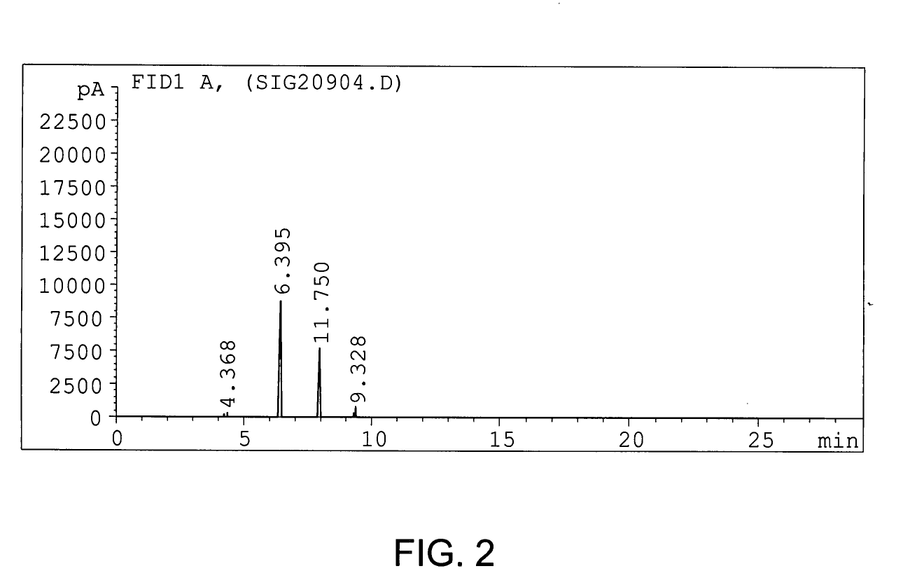

As shown in FIG. 1, monomer prepared according to the prior art method (triflic acid catalyst) contains high molecular weight materials removed by thin film evaporating. FIG. 2 shows that monomer prepared according to the method of the invention herein contains fewer high molecular weight materials removable by thin film evaporation.

Following, the method of the invention is described in more detail by way of examples, which, however, never limit the scope of the invention in any way. The Examples and Comparative Examples were prepared by combining the materials as described and allowing them to react at room temperature with agitation for 48 hours unless expressly stated otherwise. All numerical values should be considered to be modified by the term “about” unless specifically identified otherwise. Unless specified otherwise, in each example and comparative example 11.25 grams of V2, 50 grams of distilled D4 and 2.25 grams of resin was used. The product was then filtered and placed over solid sodium bicarbonate for two days. The product formed was vacuum stripped at 80° C. for about four hours and then weighed for yield and analyzed for Mn, Mw and polydispersity (Pd). Color of the final sample was determined by visual inspection. Mn is number average molecular weight determined by Gel Permeation Chromatography (GPC). Mw is weight average molecular weight determined by GPC. All resins were obtained from Sigma Aldrich.

### EXAMPLES

### Comparative Example 1

### V2D25 Synthesis Using Ion Exchange Resin at Room Temperature

CAS #39389-20-3 AMBERLYST 15 add 0.1 gram MeOH anhydrous to pot after resin V2 D4 added

| GPC | | | |
|---|---|---|---|
| (Yellow) | Mn | Mw | Pd |
| Yield 9.9 grams | 1437 | 2037 | 1.42 |

### Comparative Example 2

### V2D25 Synthesis Using Ion Exchange Resin at Room Temperature

CAS #39389-20-3 AMBERLYST 15 add 0.1 gram MeOH (anhydrous) to resin before V2 and D4 added

| GPC | | | |
|---|---|---|---|
| (yellow) | Mn | Mw | Pd |
| Yield 10.8 grams | 1500 | 2239 | 1.49 |

### Comparative Example 3

### V2D25 Synthesis Using Ion Exchange Resin at Room Temperature

CAS #39389-20-3 Amberlyst 15 add 0.1 gram DI water to pot after resin, V2, and D4 added

| GPC | | | |
|---|---|---|---|
| (Clear) | Mn | Mw | Pd |
| Yield 13.1 grams | 2792 | 5015 | 1.79 |

### Comparative Example 4

### V2D25 Synthesis Using Ion Exchange Resin at Room Temperature

3.68 grams V2

16.32 grams distilled D4

1.0 grams resin

CAS #9037-24-5 AMBERLYST 15 95% solids No water added

| GPC | Mn | Mw | Pd |
|---|---|---|---|
| 24 hours | 1736 | 2883 | 1.66 |
| Filter at 96 hours | 1954 | 3383 | 1.73 |
| 13.2 grams | | | |
| (yield) | | | |

### Comparative Example 5

### V2D25 Synthesis Using Ion Exchange Resin at Room Temperature

3.68 grams V2

16.32 grams distilled D4

2.0 grams resin

CAS #9037-24-5 AMBERLYST 15 RESIN # 1 95% solid

| GPC | Mn | Mw | Pd |
|---|---|---|---|
| 4 hours | 1475 | 2194 | 1.49 |
| 8 hours | 1771 | 2730 | 1.54 |
| 24 hours | 1999 | 3363 | 1.68 |
| 48 hours | 1915 | 3422 | 1.79 |
| 72 hours | 2001 | 3609 | 1.80 |
| 96 hours | 2015 | 3660 | 1.82 |
| Filter at 96 hours | 2027 | 3576 | 1.77 |
| Yield 12.2 grams | | | |

### Comparative Example 6

### V2D25 Synthesis Using Ion Exchange Resin at Room Temperature

4.0 grams resin

CAS #9037-24-5 AMBERLYST 15 RESIN #1 95% solids

| | Mn | Mw | Pd |
|---|---|---|---|
| 4 hours | 1774 | 2819 | 1.59 |
| 8 hours | 1952 | 3179 | 1.63 |
| 24 hours | 2144 | 3793 | 1.77 |
| 48 hours | 2163 | 4089 | 1.89 |
| 72 hours | 2289 | 4442 | 1.94 |
| 96 hours | 2263 | 4404 | 1.95 |
| Filter at 96 hours | 2257 | 4407 | 1.96 |
| Yield 10.5 grams | | | |

### Example 1

### V2D25 Synthesis Using Ion Exchange Resin at Room Temperature

CAS #39389-20-3 AMBERLYST 15 add 0.1 gram DI water to resin before V2 and D4 added

| GPC | | | |
|---|---|---|---|
| (Clear) | Mn | Mw | Pd |
| Yield 13.5 grams | 2831 | 5245 | 1.84 |

### Example 2

### V2D25 Synthesis Using Ion Exchange Resin at Room Temperature

CAS #39389-20-3 AMBERLYST 15 100% solids add 0.05 grams of water to the resin GPC

| GPC | Mn | Mw | Pd |
|---|---|---|---|
| 24 hours | 1545 | 2302 | 1.49 |
| Filter at 96 hours | 2001 | 3335 | 1.67 |
| 12.9 grams (yield) | | | |

### Example 3

### V2D25 Synthesis Using Ion Exchange Resin at Room Temperature

AMBERLYST 15 dry 7-9291 100% solids add 0.05 grams of water to the resin

| GPC | Mn | Mw | Pd |
|---|---|---|---|
| 24 hours | 1732 | 2932 | 1.69 |
| Filter at 96 hours | 1858 | 3244 | 1.75 |
| 14.6 grams (yield) | | | |

### Example 4

### V2D25 Synthesis Using Ion Exchange Resin at Room Temperature

3.68 grams V2

16.32 grams distilled D4

1.0 grams resin

CAS #9037-24-5 AMBERLYST 15 RESIN #4 100% solids 0.05 grams water added

| GPC | Mn | Mw | Pd |
|---|---|---|---|
| 72 hours | 1900 | 3452 | 1.82 |
| 96 hours | 1904 | 3433 | 1.80 |
| Filter at 96 hours | 2033 | 3556 | 1.75 |
| 13.25 grams (yield) | | | |

### Example 5

### V2D25 Synthesis Using Ion Exchange Resin at 60 C

3.68 grams V2

16.32 grams distilled D4

1.0 grams resin

AMBERLYST 15 RESIN 99.7% solids 0.05 grams water added

GPC

| | Mn | Mw | Pd |
|---|---|---|---|
| 2 hours | 1515 | 2508 | 1.66 |
| 4 hours | 1835 | 3108 | 1.69 |
| 6 hours | 1675 | 2887 | 1.72 |
| 8 hours | 2184 | 3852 | 1.76 |
| 16 hours | 2718 | 4933 | 1.82 |
| 24 hours | 3116 | 5732 | 1.84 |
| Filter at 24 hours | 3557 | 6450 | 1.81 |

Yield 12.3 grams

### Example 6

### V2D25 Synthesis Using Normalized Ion Exchange Resin at Room Temperature

3.68 grams V2

16.32 grams distilled D4

11.0 grams resin

AMBERLYST 15 RESIN 99.7% solids 0.047 grams water added

GPC

| | Mn | Mw | Pd |
|---|---|---|---|
| 24 hours | 1455 | 2089 | 1.44 |
| 48 hours | 1791 | 2743 | 1.53 |
| 72 hours | 2012 | 3184 | 1.58 |
| 96 hours | 2064 | 3292 | 1.59 |
| 125 hours | 2143 | 3600 | 1.68 |
| 165 hours | 2276 | 3873 | 1.70 |

Yield 10.51 grams

### Example 7

### V2D25 Synthesis Using Normalized Ion Exchange Resin at Room Temperature

3.68 grams V2

16.32 grams distilled D4

2.0 grams resin Amberlyst15 Resin 99.7% solids

AMBERLYST 15 RESIN 99.7% solids 0.094 grams water added

GPC

| | Mn | Mw | Pd |
|---|---|---|---|
| 24 hours | 1827 | 2777 | 1.52 |
| 48 hours | 2075 | 3427 | 1.65 |
| 72 hours | 2320 | 3947 | 1.70 |
| 96 hours | 2385 | 4155 | 1.74 |
| 125 hours | 2444 | 4380 | 1.79 |
| 165 hours | 2564 | 4553 | 1.78 |

Yield 12.21 grams

### Example 8

### V2D25 Synthesis Using Normalized Ion Exchange Resin at Room Temperature

| | Mn | Mw | Pd | D4/D5 | OH |
|---|---|---|---|---|---|
| 24 hours | 2411 | 4000 | 1.66 | 1.54 | |
| 48 hours | 2487 | 4375 | 1.76 | 1.61 | |
| 72 hours | 2104 | 3789 | 1.80 | 1.46 | |
| 96 hours | 2126 | 3883 | 1.83 | 1.46 | |
| 96 hours | 2044 | 3731 | 1.83 | 0.67 | |

### Example 9

### V2D25 Synthesis Using Normalized Ion Exchange Resin at Room Temperature

3.68 grams V2

16.32 grams distilled D4

2.0 grams resin Amberlyst 15 Resin 99.7% solids

Water added directly to resin before D4 and V2 added

AMBERLYST 15 RESIN 99.7% solids 0.470 grams water added (25%)

| | Mn | Mw | Pd | D4/D5 | OH |
|---|---|---|---|---|---|
| 24 hours | 1768 | 2791 | 1.58 | 1.48 | |
| 48 hours | 1818 | 3046 | 1.68 | 1.50 | |
| 72 hours | 1835 | 3157 | 1.72 | 1.32 | |
| 96 hours | 1788 | 3127 | 1.75 | 1.58 | |
| 96 hours | 1733 | 3121 | 1.80 | 1.10 | |

### Example 10

### V2D25 Synthesis Using Normalized Ion Exchange Resin at Room Temperature

3.68 grams V2

16.32 grams distilled D4

2.0 grams resin Amberlyst 15 Resin 99.7% solids

Water added directly to resin before D4 and V2 added AMBERLYST 15 RESIN 99.7% solids 0.188 grams water added (10%)

| | Mn | Mw | Pd | D4/D5 | OH |
|---|---|---|---|---|---|
| 24 hours | 2289 | 3875 | 1.69 | 1.70 | |
| 48 hours | 1953 | 3454 | 1.77 | 1.54 | |
| 72 hours | 1964 | 3500 | 1.78 | 1.47 | |
| 96 hours | 1956 | 3504 | 1.80 | 1.48 | |
| 96 hours | 1925 | 3498 | 1.82 | 0.53 | |

Analysis

The examples and comparative examples demonstrate the desirability of using a water content standardized (normalized) ion exchange resin to obtain a colorless product having the desired degree of polydispersity.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. A method of forming monomers; the method comprising:
extracting an ion-exchange resin with a resin expanding solvent;
washing the extracted resin with a dilute acid solution and distilled water to provide an acidified resin;
drying the acidified resin;
combining the dried resin with a specified amount of water to provide a normalized resin;
adding the normalized resin to a reaction vessel containing a cyclic oligomer and a end capped disiloxane oligomer at a concentration to yield a monomer reaction product having a desired statistical chain length;
mixing the contents of the reaction vessel under conditions suitable for a reaction to occur followed by filtration to remove the ion-exchange resin to provide a monomer product.

2. The method of claim 1 wherein the resin expanding solvent is selected from the group consisting of THF, polar solvents, acetyl nitrile, toluene and mixtures thereof.

3. The method of claim 1 wherein the resin expanding solvent is HPLC grade.

4. The method of claim 1 wherein the step of washing the ion-exchange resin with resin expanding solvent is conducted until the resin is substantially decolorized.

5. The method of claim 1 wherein the step of drying the acidified resin is conducted until the acidified resin reaches constant weight.

6. The method of claim 1 wherein the amount of water added to the dried resin controls the amount of mono-functional product produced by the reaction.

7. A medical device comprising a monomer prepared by the method of claim 1.

8. The device of claim 7 wherein the medical device is selected from the group consisting of contact lenses, phakic intraocular lenses, aphakic intraocular lenses and corneal implants.

9. A method of providing an optically clear monomer, the method comprising:
reacting a cyclic organopolysiloxane oligomer having the following formula I: 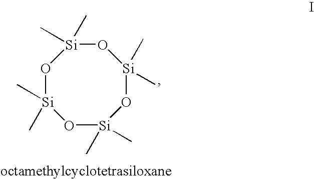
with a end capped disiloxane oligomer having the following formula II: 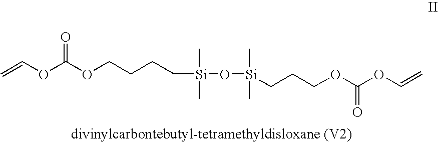
in the presence of a cation-exchange resin in the water standardized acidic form to provide a polymerization mixture.

10. The method of claim 9 wherein the amount of the cation-exchange resin in the polymerization mixture is in the range from about 5 to about 15% by weight based on the amount of the cyclic organopolysiloxane oligomer or oligomers.

11. The method of claim 9 wherein the amount of the cation-exchange resin in the polymerization mixture is in the range from about 3% to about 5% by weight based on the amount of the cyclic organopolysiloxane oligomer or oligomers.

12. The method of claim 9 where the mixture of the compound of Formula I, the compound of formula II and the cation-exchange resin in the water standardized acidic form is agitated at room temperature for a length of time sufficient to effect the ring-opening polymerization of the cyclic oligomer or oligomers.

13. The method of claim 12 wherein the mixture is agitated for from about 4 to about 120 hours.
